(19) United States
(12) Patent Application Publication
(10) Pub. No.: US 2007/0275315 A1
(43) Pub. Date: Nov. 29, 2007

(54) TONER, METHOD FOR MANUFACTURINGTHE TONER, AND DEVELOPER, IMAGE FORMING METHOD, IMAGE FORMING APPARATUS AND PROCESS CARTRIDGE USING THE TONER

(76) Inventors: Tsuneyasu Nagatomo, Numazu-shi (JP); Masayuki Ishii, Numazu-shi (JP); Hiroshi Yamashita, Numazu-shi (JP); Yasutada Shitara, Numazu-shi (JP); Tatsuya Morita, Fujisawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/752,343

(22) Filed: May 23, 2007

(30) Foreign Application Priority Data
May 23, 2006 (JP) 2006-142867

(51) Int. Cl. G03G 9/08; G03G 21/00

(52) U.S. Cl. 430/108.1; 430/137.1; 430/119.86

(57) ABSTRACT

A toner is provided manufactured by a method including mixing a particulate porous cross-linked resin having pores on a surface thereof and a volume average particle diameter of from 15 to 50 μm with a pre-toner including a colored particulate material comprising a binder resin, a colorant, and a release agent and an external additive, and removing the particulate porous cross-linked resin; along with a method for manufacturing the above toner, and a developer, an image forming method, an image forming apparatus, and process cartridge using the toner.

### BACKGROUND OF THE INVENTION

1. Field of the Invention

The present invention relates a toner for use in electrophotography. In addition, the present invention also relates to a method for preparing a toner, a developer, an image forming method, an image forming apparatus, and a process cartridge.

2. Discussion of the Background

As an external additive of a toner, particulate materials having a particle diameter of several to several tens of nanometers have been generally used. Most of the fine particles of a particulate material are present as primary particles, while the rest are present as aggregates constituted of several to several hundreds of the fine particles. The particulate material typically has a particle diameter distribution, as same as a toner, and includes coarse particles having a particle diameter of several micrometers.

An external additive is mixed with a toner using a mixer so that the external additive adheres to the surface of the toner, while breaking the aggregates of the external additive particles. Some of the external additive particles do not adhere to the toner and exist freely. In addition, some of the external additive particles adhered to the toner tend to release therefrom due to the reception of mechanical stresses in a developing device, etc., and exist freely.

These external additive particles exiting freely (hereinafter referred to as free external additive particles) tend to move onto the surface of a photoreceptor when a toner is developed thereon, and remain thereon even after the toner is transferred. Further, the remaining free external additive particles tend not to be removed by a cleaner. When such free external additive particles accumulate on the surface of the photoreceptor, a filming problem such that a film of the external additive particles is formed thereon tends to occur and scratches are made thereon, resulting in shorten the life of the photoreceptor. In addition, the free external additive particles tend to fall off from a developing device, resulting in contamination of the inside wall of the machine used. Furthermore, the free external additive particles tend to adhere to the surface of a carrier included in a developer and prevent charges from giving and receiving between the toner and the carrier, resulting in deterioration of charged level of the toner.

### SUMMARY OF THE INVENTION

Accordingly, an object of the present invention is to provide a toner which has good cleanability and capable of stably producing high quality images.

Another object of the present invention is to provide a method for manufacturing the above toner.

Yet another object of the present invention is to provide a developer which has a long life.

A further object of the present invention is to provide an image forming method, an image forming apparatus, and a process cartridge by which images having good image qualities can be stably produced without making scratches on a photoreceptor.

These and other objects of the present invention, either individually or in combinations thereof, as hereinafter will become more readily apparent can be attained by a toner manufactured by a method, comprising:

mixing a particulate porous cross-linked resin having pores on a surface thereof and a volume average particle diameter of from 15 to 50 μm with a pre-toner comprising:
a colored particulate material comprising a binder resin, a colorant, and a release agent; and
an external additive; and

removing the particulate porous cross-linked resin; a method for manufacturing the above toner; and a developer, an image forming method, an image forming apparatus, and process cartridge using the toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of the process cartridge of the present invention;

FIG. 2 is a schematic view illustrating an embodiment of the image forming apparatus of the present invention;

FIGS. 3A and 3B are schematic views illustrating another embodiments of the image forming apparatus of the present invention;

FIG. 4 is a schematic view illustrating yet another embodiment of the image forming apparatus of the present invention; and

FIG. 5 is a schematic view illustrating an embodiment of the image forming unit of the image forming apparatus illustrated in FIG. 4.

### DETAILED DESCRIPTION OF THE INVENTION

Generally, the present invention provides a toner manufactured by a method including mixing a particulate porous resin having pores on a surface thereof with a pre-toner including a colored particulate material and an external additive so that free external additive particles are collected into the pores of the particulate porous resin, and removing the particulate porous resin. The object of this method is to prevent the occurrence of image defect resulting from the existence of free external additive particles and to lengthen the life of the toner and the image forming apparatus used. By mixing a specific particulate porous resin with a pre-toner, cleanability of the resultant toner increases, high quality images are stably produced, and the surface of a photoreceptor is prevented from making scratches thereon.

### Toner

The toner of the present invention includes an external additive; and a colored particulate material including a binder resin, a colorant, a release agent, and optionally a layered inorganic compound. The toner may include other components, if desired.

### (Binder Resin)

Any known resins can be used as the binder resin of the toner of the present invention, and are not particularly limited. Specific examples of the binder resins include, but are not limited to, homopolymers and copolymers of styrenes (e.g., styrene, chlorostyrene), monoolefins (e.g., ethylene, propylene, butylene, isoprene), vinyl esters (e.g., vinyl acetate, vinyl propionate, vinyl benzoate, vinyl lactate), monocarboxylic acid esters of α-methylene series (e.g., methyl acrylate, ethyl acrylate, butyl acrylate, dodecyl acrylate, octyl acrylate, phenyl acrylate, methyl methacrylate, ethyl methacrylate, butyl methacrylate, dodecyl methacrylate), vinyl ethers (e.g., vinyl methyl ether, vinyl ethyl ether, vinyl butyl ether), and vinyl ketones (e.g., vinyl methyl ketone, vinyl hexyl ketone, vinyl isopropenyl ketone). Specifically, polystyrene resins, polyester resins, styrene-alkyl acrylate copolymers, styrene-alkyl methacrylate copolymers, styrene-acrylonitrile copolymers, styrene-butadiene copolymers, styrene-maleic anhydride copolymers, polyethylene resins, polypropylene resins may be used. Among these resins, polyester resins are preferable, and particularly, polyester resins having a urea group such as a urea-modified polyester resins are more preferable. In particular, a combination of a urea-modified polyester resin and unmodified polyester resin is most preferable.

### (Colorant)

Specific examples of the colorants for use in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

The toner preferably includes a colorant in an amount of from 1 to 15% by weight, and more preferably from 3 to 10% by weight. When the amount is too small, coloring power of the resultant toner deteriorates. When the amount is too large, the colorant cannot be well dispersed in the toner, resulting in deterioration of coloring power and electrical properties of the resultant toner.

The colorant for use in the present invention can be combined with a resin to be used as a master batch. Specific examples of the resins for use in the master batch include, but are not limited to, styrene polymers, substituted styrene polymers, styrene copolymers, polymethyl methacrylates, polybutyl methacrylates, polyvinyl chlorides, polyvinyl acetates, polyethylenes, polypropylenes, polyesters, epoxy resins, epoxy polyol resins, polyurethanes, polyamides, polyvinyl butyrals, polyacrylic acids, rosins, modified rosins, terpene resins, aliphatic or alicyclic hydrocarbon resins, aromatic petroleum resins, chlorinated paraffins, and paraffin waxes. These resins can be used alone or in combination.

Specific examples of the styrene polymers and substituted styrene polymers include, but are not limited to, polystyrenes, poly-p-chlorostyrenes, and polyvinyltoluenes. Specific examples of the styrene copolymers include, but are not limited to, styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butylmethacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleic acid ester copolymers.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

### (Release Agent)

Any known release agents can be used as the release agent of the toner of the present invention, and are not particularly limited. As the release agent, waxes are preferably used.

Specific examples of the waxes include, but are not limited to, waxes having a carbonyl group, polyolefin waxes, and long-chain hydrocarbons. These can be used alone or in combination. Among these waxes, waxes having a carbonyl group are preferably used.

Specific examples of the waxes having a carbonyl group include, but are not limited to, polyalkanoic acid esters, polyalkanol esters, polyalkanoic acid amides, polyalkylamides, and dialkyl ketones. Specific examples of the polyalkanoic acid esters include, but are not limited to, carnauba wax, montan wax, trimethylolpropane tribehenate, pentaerythritol tetrabehenate, pentaerythritol diacetate dibehenate, glycerin tribehenate, and 1,18-octadecanediol distearate. Specific examples of the polyalkanol esters include, but are not limited to, tristearyl trimellitate and distearyl maleate. Specific examples of the polyalkanoic acid amides include, but are not limited to, dibehenyl amide. Specific examples of the polyalkylamides include, but are not limited to, trimellitic acid tristearyl amide. Specific examples of the dialkyl ketones include, but are not limited to, distearyl ketone. Among these waxes having a carbonyl group, polyalkanoic acid esters are preferably used.

Specific examples of the polyolefin waxes include, but are not limited to, polyethylene waxes and polypropylene waxes.

Specific examples of the long-chain hydrocarbons include, but are not limited to, paraffin waxes and SASOL waxes.

The release agent preferably has a melting point of from 40 to 160° C., preferably from 50 to 120° C., and much more preferably from 60 to 90° C. When the melting point is too small, thermostable preservability of the resultant toner deteriorates When the melting point is too large, cold offset tends to occur when the resultant toner is fixed at low temperatures.

The release agent preferably has a melt viscosity of 5 to 1000 cps (mPa·s), and more preferably from 10 to 100 cps, when measured at a temperature larger than the melting point thereof by 20° C. When the melt viscosity is too small, releasability of the resultant toner deteriorates. When the melt viscosity is too large, hot offset resistance and low temperature fixability of the resultant toner deteriorates.

The toner preferably includes the release agent in an amount of from 0 to 40% by weight, and more preferably from 3 to 30% by weight. When the amount is too large, fluidity of the resultant toner deteriorates.

### (External Additive)

Any known external additives can be used as the external additive of the toner of the present invention, and are not particularly limited. The external additive for use in the present invention preferably has a volume average particle diameter of from 10 to 300 nm and a BET specific surface area of from 20 to 300 m²/g. The external additives include at least one member selected from a silica, a titanium compound, an alumina, a cerium oxide, a calcium carbonate, a magnesium carbonate, a calcium phosphate, a fluorine-containing particulate resin, a silica-containing particulate resin, and a nitrogen-containing particulate resin. In the present invention, these are preferably used in combination.

The external additive for use in the present invention preferably includes a titanium compound. The titanium compound is preferably prepared by reacting TiO(OH)₂, which is prepared by a wet method (in particular, hydrolysis method), with a silane compound or a silicone oil.

Specific examples of the silane compounds include, but are not limited to, silane coupling agents such as CH₃Si(Cl)₃, CH₃Si(OCH₃)₃, CH₃Si(OC₂H₅)₃, CH₃CH₂Si(OCH₃)₃, CH₃(CH₂)₂Si(OCH₃)₃, CH₃(CH₂)₃Si(OCH₃)₃, CH₃(CH₂)₄Si(OCH₃)₃, CH₃(CH₂)₅Si(OCH₃)₃, CH₃(CH₂)₆Si(OCH₃)₃, CH₃(CH₂)₇Si(OCH₃)₃, CH₃(CH₂)₈Si(OCH₃)₃, CH₃(CH₂)₉Si(OCH₃)₃, CH₃(CH₂)₁₀Si(OCH₃)₃, CH₃(CH₂)₁₁Si(OCH₃)₃, CH₃(CH₂)₁₂Si(OCH₃)₃, CH₃(CH₂)₁₃Si(OCH₃)₃, CH₃(CH₂)₁₄Si(OCH₃)₃, CH₃(CH₂)₁₅Si(OCH₃)₃, CH₃(CH₂)₁₆Si(OCH₃)₃, CH₃(CH₂)₁₇Si(OCH₃)₃, CH₃(CH₂)₁₈Si(OCH₃)₃, CH₃(CH₂)₁₉Si(OCH₃)₃, CH₃(CH₂)₅Si(OC₂H₅)₃, CH₃(CH₂)₆Si(OC₂H₅)₃, CH₃(CH₂)₇Si(OC₂H₅)₃, CH₃(CH₂)₈Si(OC₂H₅)₃, CH₃(CH₂)₉Si(OC₂H₅)₃, CH₃(CH₂)₁₀Si(OC₂H₅)₃, CH₃(CH₂)₁₁Si(OC₂H₅)₃, CH₃(CH₂)₁₂Si(OC₂H₅)₃, CH₃(CH₂)₁₃Si(OC₂H₅)₃, CH₃(CH₂)₁₄Si(OC₂H₅)₃, CH₃(CH₂)₁₅Si(OC₂H₅)₃, CH₃(CH₂)₁₆Si(OC₂H₅)₃, CH₃(CH₂)₁₇Si(OC₂H₅)₃, CH₃(CH₂)₁₈Si(OC₂H₅)₃, CH₃(CH₂)₁₉Si(OC₂H₅)₃, CF₃Si(OCH₃)₃, CF₃Si(NCO)₃, (CH₃)₂SiCl₂, (CH₃)₂Si(OCH₃)₂, (CH₃)₂Si(OC₂H₅)₂, CH₃(CH₃CH₂)Si(OCH₃)₂, (CH₃)[CH₃(CH₂)₂]Si(OCH₃)₂, (CH₃)[CH₃(CH₂)₃]Si(OCH₃)₂, (CH₃)[CH₃(CH₂)₄]Si(OCH₃)₂, (CH₃)[CH₃(CH₂)₅]Si(OCH₃)₂, (CH₃)[CH₃(CH₂)₆]Si(OCH₃)₂, (CH₃)[CH₃(CH₂)₇]Si(OCH₃)₂, (CH₃)[CH₃(CH₂)₈]Si(OCH₃)₂, (CH₃)[CH₃(CH₂)₉]Si(OCH₃)₂, (CH₃)[CH₃(CH₂)₁₀]Si(OCH₃)₂, (CH₃)[CH₃(CH₂)₁₁]Si(OCH₃)₂, (CH₃)[CH₃(CH₂)₁₂]Si(OCH₃)₂, (CH₃)[CH₃(CH₂)₁₃]Si(OCH₃)₂, (CH₃)[CH₃(CH₂)₁₄]Si(OCH₃)₂, (CH₃)[CH₃(CH₂)₁₅]Si(OCH₃)₂, (CH₃)[CH₃(CH₂)₁₆]Si(OCH₃)₂, (CH₃)[CH₃(CH₂)₁₇]Si(OCH₃)₂, (CH₃)[CH₃(CH₂)₁₈]Si(OCH₃)₂, (CH₃)[CH₃(CH₂)₁₉]Si(OCH₃)₂, (CH₃)₂Si(NCO)₂, (CH₃)₃SiCl, (CH₃)₃Si(OCH₃), (CH₃)₃Si(OC₂H₅), (CH₃)₂(CH₃CH₂)Si(OCH₃), (CH₃)₂[CH₃(CH₂)₂]Si(OCH₃), (CH₃)₂[CH₃(CH₂)₃]Si(OCH₃), (CH₃)₂[CH₃(CH₂)₄]Si(OCH₃), (CH₃)₂[CH₃(CH₂)₅]Si(OCH₃), (CH₃)₂[CH₃(CH₂)₆]Si(OCH₃), (CH₃)₂[CH₃(CH₂)₇]Si(OCH₃), (CH₃)₂[CH₃(CH₂)₈]Si(OCH₃), (CH₃)₂[CH₃(CH₂)₉]Si(OCH₃), (CH₃)₂[CH₃(CH₂)₁₀]Si(OCH₃), (CH₃)₂[CH₃(CH₂)₁₁]Si(OCH₃), (CH₃)₂[CH₃(CH₂)₁₂]Si(OCH₃), (CH₃)₂[CH₃(CH₂)₁₃]Si(OCH₃), (CH₃)₂[CH₃(CH₂)₁₄]Si(OCH₃), (CH₃)₂[CH₃(CH₂)₁₅]Si(OCH₃), (CH₃)₂[CH₃(CH₂)₁₆]Si(OCH₃), (CH₃)₂[CH₃(CH₂)₁₇]Si(OCH₃), (CH₃)₂[CH₃(CH₂)₁₈]Si(OCH₃), and (CH₃)₂[CH₃(CH₂)₁₉]Si(OCH₃).

Specific examples of the silicone oils include, but are not limited to, dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, acrylic-modified silicone oil, methacrylic-modified silicone oil, and α-methylstyrene-modified silicone oil.

The reaction between TiO(OH)₂ and these silane compounds or silicone oils is performed as follows. For example, a method in which TiO(OH)₂ is immersed in a solution of a silane compound or a silicone oil and then dried can be mentioned. In particular, a method in which TiO(OH)₂ particles are immersed in a solution including a coupling agent and then dried, and a method in which a solution including a coupling agent is sprayed on TiO(OH)₂ particles and then dried can be mentioned as typical methods using a coupling agent.

The amount of the coupling agent adhered to TiO(OH)₂ particles is preferably 0.1 to 25% by weight based on total weight of TiO(OH)₂ particles.

The titanium compound preferably has a specific gravity of from 2.8 to 3.6.

The toner preferably includes the external additive in an amount of from 0.1 to 8.0% by weight.

### (Particulate Porous Cross-Linked Resin)

The toner of the present invention is manufactured by a method including mixing a particulate porous cross-linked resin having pores on the surface thereof and a volume average particle diameter of from 25 to 50 μm with a pre-toner, and removing the particulate porous cross-linked resin.

The volume average particle diameter of the particulate porous cross-linked resin can be determined by COULTER MULTISIZER II (manufactured by Coulter Electrons Inc.), for example.

The particulate porous cross-linked resin may be removed with a sieve having openings smaller than the volume average particle diameter thereof.

The above method may further include mixing a colored particulate material and an external additive to prepare the pre-toner.

The particulate porous cross-linked resin further has a cross-linking density of from 3 to 15% by weight, a volume average particle diameter of from 15 to 50 μm, a total volume of the pores of from 0.01 to 0.50 cc/g (i.e., 0.01 to 0.50 ml/g), a specific surface area of from 5 to 50 m²/g, and an average diameter of the pores of from 0.01 to 2.0 μm.

The specific surface area can be determined by nitrogen multipoint BET method, a total volume of pores can be determined by mercury intrusion porosimetry, and diameters of the pores can be determined by SEM observation.

The particulate porous cross-linked resin can be prepared by copolymerizing 50 to 96 parts by weight of an alkyl acrylate or alkyl methacrylate, 3 to 15 parts by weight of a polyfunctional monomer having 2 or more vinyl groups, and 1 to 35 parts by weight of a copolymerizable monomer, in the presence of a pore-forming agent.

Specific examples of the alkyl (meth)acrylates include, but are not limited to, (meth)acrylates having an alkyl group having 1 to 100 carbon atoms and which may have a substituent group, such as methyl(meth)acrylate, ethyl(meth)acrylate, n-butyl(meth)acrylate, propyl(meth)acrylate, butyl(meth)acrylate, pentyl(meth)acrylate, hexyl(meth)acrylate, heptyl(meth)acrylate, nonyl(meth)acrylate, acyl(meth)acrylate, cyclohexyl(meth)acrylate, octyl acrylate, and 2-chloroethyl acrylate.

Specific examples of the polyfunctional monomers having 2 or more vinyl groups include, but are not limited to, (1) aliphatic conjugated diene monomers and (2) compounds having 2 or more functional groups capable of addition polymerizing.

Specific examples of the (1) aliphatic conjugated diene monomers include, but are not limited to, butadiene, isoprene, dimethylbutadiene, and chloroprene.

Specific examples of the (2) compounds having 2 or more functional groups capable of addition polymerizing include, but are not limited to, trimethylolpropane di(meth)acrylate, trimethylolpropane tri(meth)acrylate, divinylbenzene, ethylene glycol di(meth)acrylate, pentaerythritol tri(meth)acrylate, pentaerythritol tetra(meth)acrylate, 1,4-butanediol di(meth)acrylate, 1,6-hexanediol di(meth)acrylate, triethylene glycol di(meth)acrylate, tetraethylene glycol di(meth)acrylate, 1,3-butylene glycol di(meth)acrylate, neopentyl glycol di(meth)acrylate, pentaerythritol di(meth)acrylate, glycerol di(meth)acrylate, glycerol di(meth)acrylate, glycerol allyloxy di(meth)acrylate, 1,1,1-trishydroxymethylethane di(meth)acrylate, 1,1,1-trishydroxymethylethane tri(meth)acrylate, 1,1,1-trishydroxymethylpropane di(meth)acrylate, 1,1,1-trishydroxymethylpropane tri(meth)acrylate, triallyl cyanurate, triallyl isocyanurate, triallyl trimellitate, diallyl terephthalate, and diallyl phthalate.

Specific examples of the copolymerizable monomers include, but are not limited to, acrylic acid, methacrylic acid, maleic acid, monoethyl maleate, itaconic acid, fumaric acid, citraconic acid, protonic acid, vinylsulfonic acid, styrene-p-sulfonic acid, 2-acrylamide-2-methylpropane sulfonic acid, 2-sulfoxyethyl methacrylate, monomers having a hydroxyl group (e.g., 2-hydroxyethyl acrylate, hydroxypropyl acrylate, 2-hydroxyethyl methacrylate, hydroxypropyl methacrylate, hydroxybutyl acrylate, hydroxybutyl methacrylate, allyl alcohol, methallyl alcohol), N-(4-hydroxyphenyl)acrylamide, N-(4-hydroxyphenyl)methacrylamide, o-hydroxystyrene, m-hydroxystyrene, p-hydroxystyrene, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, polymerizable acrylamides (e.g., acrylamide, methacrylamide, N-methylol acrylamide, N-methylol methacrylamide, N-ethyl acrylamide, N-hexyl acrylamide, N-cyclohexyl acrylamide, N-hydroxyethyl acrylamide, N-phenyl acrylamide, N-nitrophenyl acrylamide, N-ethyl-N-phenyl acrylamide), nitrogen-containing acrylates and methacrylates (e.g., dimethylaminoethyl acrylate, dimethylaminoethyl methacrylate), vinyl ethers (e.g., ethyl vinyl ether, 2-chloroethyl vinyl ether, hydroxyethyl vinyl ether, propyl vinyl ether, butyl vinyl ether, octyl vinyl ether, phenyl vinyl ether), vinyl esters (e.g., vinyl acetate, vinylchloro acetate, vinyl butyrate, vinyl benzoate), styrenes (e.g., styrene, α-methylstyrene, methylstyrene, chloromethylstyrene), vinyl ketones (e.g., methyl vinyl ketone, ethyl vinyl ketone, propyl vinyl ketone, phenyl vinyl ketone), olefins (e.g., ethylene, propylene, isobutylene, glycidyl(meth)acrylate), polymerizablenitriles (e.g., acrylonitrile, methacrylonitrile, N-vinylpyrrolidone, N-vinylcarbazol, 4-vinylpyridine), amphoteric ion monomers (e.g., N,N-dimethyl-N-methacryloxyethyl-N-(3-sulfopropyl)ammonium-betain), N,N-dimethyl-N-methacrylamidepropyl-N-(3-sulfopropyl)ammoni um-betain), 1-(3-sulfopropyl)-2-vinylpyridinium-betain, and reaction products of the above monomers with compounds having a functional group capable of reacting with the monomers (e.g., a reaction product of a monomer having a hydroxyl group with an isocyanate compound, a reaction product of a monomer having a carboxyl group with a compound having a glycidyl group) These monomers can be used alone or in combination.

### (Pore-Forming Agent)

The pore forming-agent is known and described as porogen. The pore-forming agent forms pores on particulate polymer at a time when the polymer is synthesized. Several kinds of pore-forming agents are known.

For example, solvents which are miscible with a monomer mixture and immiscible with the resultant polymer, such as toluene, isooctane, and methyl isobutyl ketone, are known. In this case, the pore-forming agent (i.e., the solvent) is removed by drying the resultant particulate polymer. As a result, pores are formed on portions at which the solvent is removed.

As another example, inorganic materials which can be dissolved by strong acids, such as calcium carbonate and tricalcium phosphate, are known. In this case, the pore-forming agent (i.e., the inorganic material) is removed when the resultant particulate polymer is purified with a strong acid. Pores are formed on portion at which the inorganic material is dissolved by the strong acid.

As yet another example, straight-chain polymers which can be dissolved in a monomer mixture are known. In this case, the straight-chain polymer is gradually phase-separated as the monomers are polymerized. As a result, pores are formed on portions at which the straight-chain polymer is phase-separated. The shape and size of the resultant pores depend on the kind of the straight-chain polymer. The straight-chain polymer for use in the present invention is not particularly limited.

In the present invention, the method for preparing the pore-forming agent is not limited to the above-mentioned methods. These methods can be used alone or in combination. The amount of the pore-forming agent used is typically 10 to 200 parts by weight, and preferably 30 to 150 parts by weight, based on 100 parts by weight of the monomer mixture. When the amount is too small, the total volume of the pores, the surface area, and the average diameter of the pores decrease. In contrast, when the amount is too large, the average diameter of the pores is too large (i.e., fine pores cannot be formed).

### (Layered Inorganic Compound)

The layered inorganic compound has a structure such that plural sheets constituted of atoms which are bound with each other by a strong force such as a covalent bond and densely arranged are stacked in layers in parallel by a weak force such as van der Waals's force and electrostatic force. Such a layered inorganic compound swells or cleaves when a solvent is coordinated to or absorbed in interlayer portions.

Specific examples of the layered inorganic compounds include, but are not limited to, swelling hydrated silicates such as smectite group clay minerals (e.g., bentonite, montmorillonite, beidellite, nontronite, saponite, hectorite, sauconite, stevensite), vermiculite group clay minerals (e.g., vermiculite), kaolin minerals (e.g., halloysite, kaolinite, endellite, dickite), phyllosilicates (e.g., talc, pyrophylite, mica, margarite, muscovite, phlogopite, tetrasililic mica, tainiolite), serpentine group minerals (e.g., antigorite), and chlorite group minerals (e.g., chlorite, cookeite, pennantite). These layered inorganic compounds may be both of natural and synthetic products. These compounds can be used alone or in combination. Among these, natural or synthetic smectite group clay minerals are preferably used because these can be effective at low additive amounts without deteriorating the resultant toner properties.

The interlayer ion (such as a metal cation) of the layered inorganic compound can be exchanged with an organic ion (i.e., intercalation).

The cation exchange capacity of the layered inorganic compound is preferably from 80 to 120 mEq/100 g, and more preferably from 90 to 110 mEq/100 g. When the cation exchange capacity is too small, exchanged amount of an organic ion is too small, and therefore solubility in a solvent and compatibility with a binder resin deteriorates. As a result, such a layered inorganic compound is insufficiently incorporated in the resultant toner, and therefore the toner shape cannot be well controlled. When the cation exchange capacity is too large, exchanged amount of an organic ion is too large and excessive organic ions tend to plasticize a binder resin. As a result, fixability and hot offset resistance of the resultant toner deteriorates.

The cation exchange capacity can be measured by the following method, for example. A cation saturated with an inherent exchange group of the layered inorganic compound is exchanged with ammonium ion using an ammonium acetate solution, and then excessive ammonium acetate is washed with an alcohol. The exchanged ammonium ion is leached using a potassium chloride solution, and then quantified by indophenol method in which the blueness of indophenol is measured by adding a mixture liquid of potassium hydroxide, phenol, and sodium nitroprusside and a sodium hypochlorite solution. Thus, the cation exchange capacity can be measured.

The layered inorganic compound may be organized with an organizing agent so as to be dispersed in an organic solvent. Such an organized layered inorganic compound can be easily dispersed in an oil phase containing toner components because of having oleophilic property. When an oil phase containing a layered inorganic compound and toner components is emulsified in a water phase by applying a shearing force, the layered inorganic compound migrates to the surface of a droplet of the oil phase because of having hydrophilic property. The viscosity of the surface of the droplet increases, and therefore the resultant toner is easily shape-controlled. The layered inorganic compound is finely dispersed in the resultant toner, and controls not only the chargeability but also the shape of the resultant toner by existing at the surface of the resultant toner in large quantity.

Specific examples of the organic solvents include, but are not limited to, acetone, methyl alcohol, ethyl alcohol, isopropyl alcohol, tetrahydrofuran (THF), and ethyl acetate. Among these, ethyl acetate is preferably used.

The layered inorganic compound can be organized by including a compound having an onium ion. In particular, the layered inorganic compound can be treated with an organizing agent including an organic onium ion to be organized. Specific examples of the onium ions include, but are not limited to, primary, secondary, tertiary, and quaternary monoalkyl ammonium ions; secondary and tertiary dialkyl ammonium ions; tertiary and quaternary trialkyl ammonium ions; and tetraalkyl ammonium ions. Among these, quaternary ammonium ions are preferably used. In particular, the following compound is preferably used:

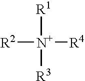

wherein R¹ represents an alkyl group having 1 to 30 carbon atoms or a benzyl group; each of R² and R³ independently represents (CH₂CH(CH₃)O)ₙH group, (CH₂CH₂CH₂O)ₙH group, or an alkyl group having 1 to 30 carbon atoms; R⁴ represents (CH₂CH(CH₃)O)ₙH group or (CH₂CH₂CH₂O)ₙH group; and n represents an integer of from 5 to 50.

Specific examples of quaternary ammonium salts including the above quaternary ammonium ion include, but are not limited to, dimethyl dioctadecyl ammonium bromide, trimethyl octadecyl ammonium chloride, benzyl trimethyl ammonium chloride, dimethyl benzyl octadecyl ammonium bromide, trioctyl methyl ammonium chloride, polyoxypropylene trimethyl ammonium chloride, di(polyoxypropylene)dimethyl ammonium chloride, di(polyoxyethylene)dodecyl methyl ammonium chloride, tri(polyoxypropylene)methyl ammonium chloride, tri(polyoxypropylene)methyl ammonium bromide, and CH₃(CH₃CH₂)₂N⁺(CH₂CHOCH₃)₂₅H.Cl⁻. Among these, CH₃(CH₃CH₂)₂N⁺(CH₂CHOCH₃)₂₅H.Cl⁻ is preferably used.

Specific examples of commercially available organized layered inorganic compounds include, but are not limited to, SOMASIF MAE, MTE, MEE, and MPE (synthetic micas from CO-OP chemical Co., Ltd.), LUCENTITE SAN, STN, SEN, and SPN (synthetic smectite from CO-OP chemical Co., Ltd.), and CLAYTONE® APA (from Southern Clay Products, Inc.).

### (Preparation of Colored Particulate Material)

The colored particulate material (hereinafter referred to as mother toner) for use in the toner of the present invention can be prepared by any known methods such as a pulverization method, a suspension polymerization method, an emulsion aggregation method, and a polymer suspension method.

The pulverization method includes steps of:

mixing a binder resin, a colorant, a release agent, etc., to prepare a toner constituent mixture;

melt-kneading the toner constituent mixture to prepare a kneaded mixture;

cooling and rolling the kneaded mixture to prepare a rolled mixture;

pulverizing the rolled mixture to prepare a pulverized mixture; and

classifying the pulverized mixture to prepare a mother toner.

This method optionally includes a step of applying a mechanical impact to the mother toner. In this case, the shape of the mother toner can be controlled so that the mother toner has an average circularity of from 0.97 to 1.0, for example. Such mechanical impact can be applied using machines such as HYBRIDIZER (from Nara Machinery Co., Ltd.) and MECHANOFUSION® (from Hosokawa Micron Corporation).

The suspension polymerization method includes steps of:

dispersing a colorant, a release agent, etc. in a mixture of an oil-soluble polymerization initiator and a monomer, to prepare an oil phase;

emulsifying the oil phase in an aqueous medium containing a surfactant, a solid dispersant, etc.;

polymerizing the monomer to prepare a mother toner.

The emulsion aggregation method includes steps of:

emulsifying a water-soluble polymerization initiator and a monomer in an aqueous medium in the presence of a surfactant, to prepare a latex (in a typical emulsion polymerization manner);

dispersing each of a colorant, a release agent, etc. independently in each aqueous medium to prepare respective dispersion;

mixing the latex and the dispersions so that the dispersoids (i.e., the resultant polymer, the colorant, the release agent) are aggregate so as to form aggregation particles having a desired particle diameter; and

heating and fusing the aggregation particles to prepare a mother toner.

When the monomers used for the suspension polymerization method are used for this emulsion aggregation method, a functional group can be introduced to the surface of the resultant mother toner.

An external additive can be mixed with a mother toner using known mixers such as V-form blender, HYBRIDIZATION SYSTEM (from Nara Machinery Co., Ltd.), and HENSCHEL MIXER (from Mitsui Mining Co., Ltd.). The peripheral speed of the rotation member of these mixers is preferably 10 to 150 m/s. When the peripheral speed is too small, the adherence between the mother toner and the external additive is too weak, and therefore some external additive particles release from the toner. When the peripheral speed is too large, the adherence between the mother toner and the external additive is too strong, and therefore the external additive looses its function.

### (Particle Diameter)

The toner of the present invention preferably has a volume average particle diameter (Dv) of from 3 to 8 μm, more preferably from 4 to 7 μm, and much more preferably from 5 to 6 μm. The volume average particle diameter (Dv) is defined as follows:

Dv=(Σ(nD³)/Σn)^{1/3}

wherein n represents the number of toner particles and D represents a particle diameter.

When the Dv is too small, the toner tends to fuse on the surface of the carrier by long-term agitation in a developing device, resulting in deterioration of chargeability of the carrier, when the toner is used for a two-component developer. When the toner is used for a one-component developer, problems such that the toner forms a film on a developing roller, and the toner fuses on a toner layer forming member tend to be caused. In contrast, when the Dv is too large, it is difficult to obtain high definition and high quality images. In addition, an average particle diameter of toner particles included in a developer tends to be largely changed when a part of the toner particles are replaced with fresh toner particles.

The toner preferably has the ratio (Dv/Dn) of the volume average particle diameter (Dv) to the number average particle diameter (Dn) of not greater than 1.25, more preferably from 1.00 to 1.20, and much more preferably from 1.10 to 1.20.

When the ratio (Dv/Dn) is not greater than 1.25, the toner has a relatively narrow particle diameter distribution and fixability increases. When the ratio (Dv/Dn) is less than 1.00, the toner tends to fuse on the surface of the carrier by long-term agitation in a developing device, resulting in deterioration of chargeability of the carrier, when the toner is used for a two-component developer. When the toner is used for a one-component developer, problems such that the toner forms a film on a developing roller, and the toner fuses on a toner layer forming member tend to be caused. In contrast, when the ratio (Dv/Dn) is greater than 1.20, it is difficult to obtain high definition and high quality images. In addition, an average particle diameter of toner particles included in a developer tends to be largely changed when a part of the toner particles are replaced with fresh toner particles.

The volume average particle diameter (Dv), the number average particle diameter (Dn), and the ratio (Dv/Dn) can be determined with an instrument such as COULTER MULTISIZER II (manufactured by Coulter Electrons Inc.).

### (Average Circularity)

The circularity of a particle is determined by the following equation:

C=Lo/L

wherein C represents the circularity, Lo represents the length of the circumference of a circle having the same area as that of the image of the particle and L represents the peripheral length of the image of the particle.

The toner of the present invention preferably has an average circularity of from 0.900 to 0.980, and more preferably from 0.940 to 0.980.

When the average circularity is too small (i.e., the toner is far from a true sphere), the toner has poor transferability and therefore high quality images without scattering tend not to be produced. When the average circularity is too large, the toner present on a photoreceptor and a transfer belt cannot be well removed with a cleaning blade (i.e., the toner has poor cleanability). As a result, background fouling in that the background portion of an image is soiled with toner particles remaining on the photo receptor after a toner image is transferred tends to occur when an image having a high image proportion (such as photographic images) is produced. Further, toner particles remaining on the photoreceptor tend to contaminate a charging roller which contact-charges the photoreceptor, resulting in deterioration of charging ability of the charging roller.

The shape of a particle is preferably determined by an optical detection method such that an image of the particle is optically detected by a CCD camera and analyzed. A particle suspension passes the image detector located on the flat plate so as to be detected. For example, a flow-type particle image analyzer FPIA-2100 (manufactured by Sysmex Corp.) can be used as a measurement instrument.

### (Shape Factor)

The shape factors SF-1 and SF-2 can be determined by the following method:

(1) particles of a toner are photographed using a scanning electron microscope (FE-SEM S-4200, manufactured by Hitachi Ltd.); and

(2) 300 randomly selected toner particles of photograph images are analyzed using an image analyzer (LUZEX AP manufactured by Nireco Corp.) via an interface to determine the SF-1 and SF-2.

The shape factor SF-1 represents the degree of the roundness of a toner particle, and is defined by the following equation:

SF-1=(L²/A)×(100π/4)

wherein L represents a diameter of the circle circumscribing the image of a toner particle, which image is obtained by observing the toner particle with a microscope; and A represents the area of the image.

When the SF-1 is 100, the toner particle has a true spherical form. When the SF-1 is larger than 100, the toner particles have irregular forms.

The shape factor SF-2 represents the degree of the concavity and convexity of a toner particle, and is defined by the following equation:

SF-2=(P²/A)×(100/4π)

wherein P represents the peripheral length of the image of a toner particle observed by a microscope; and A represents the area of the image.

When the SF-2 approaches 100, the toner particles have a smooth surface (i.e., the toner has few concavity and convexity). When the SF-2 is large, the toner particles are roughened.

### (Toner Color)

The color of the toner of the present invention is not limited. However, it is preferable that the toner has at least a color selected from black, cyan, magenta, and yellow. Atoner having a desired color can be prepared by choosing a proper colorant from the colorants mentioned above.

### Developer

The developer of the present invention includes at least the toner of the present invention and other components such as a carrier as appropriate. The developer may be either a one-component developer or a two-component developer.

Any known carriers can be used for the two-component developer of the present invention, and are not particularly limited. However, carriers including a core and a resin layer which covers the core are preferably used.

Any known cores can be used for the carrier, and are not particularly limited. Specific examples of the cores include, but are not limited to, manganese-strontium (Mn—Sr) materials and manganese-magnesium (Mn—Mg) materials having a magnetization of from 50 to 90 emu/g. In order to obtain images having a high image density, high-magnetization materials such as iron powders (having a magnetization of not less than 100 emu/g) and magnetites (having a magnetization of from 75 to 120 emu/g) are preferably used. In order to obtain high quality images, low-magnetization materials such as copper-zinc (Cu—Zn) materials (having a magnetization of from 30 to 80 emu/g) are preferably used, because the magnetic brushes can weakly contact a photoreceptor in such a case. These materials can be used alone or in combination.

The core preferably has a volume average particle diameter of from 10 to 200 μm, and more preferably from 40 to 100 μm. When the volume average particle diameter is too small, the carrier includes too large an amount of ultrafine particles and therefore magnetization per carrier particle decreases, resulting in occurrence of carrier scattering. When the volume average particle is too large, the carrier has too small a specific surface area and therefore carrier scattering tends to occur and image reproducibility deteriorates especially in full-color solid images.

Any known resins can be used for the resin layer, and are not particularly limited. Specific examples of the resins include, but are not limited to, amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, copolymers of vinylidene fluoride and acrylic monomer, copolymers of vinylidene fluoride and vinyl fluoride, fluoroterpolymers (e.g., terpolymer of tetrafluoroethylene and vinylidene fluoride and non-fluoride monomer), and silicone resins. These resins can be used alone or in combination.

Specific examples of the amino resins include, but are not limited to, urea-formaldehyde resins, melamine resins, benzoguanamine resins, urea resins, polyamide resins, and epoxy resins. Specific examples of the polyvinyl resins include, but are not limited to, acrylic resins, polymethyl methacrylate resins, polyacrylonitrile resins, polyvinyl acetate resins, polyvinyl alcohol resins, and polyvinyl butyral resins. Specific examples of the polystyrene resins include, but are not limited to, polystyrene resins and styrene-acrylic copolymer resins. Specific examples of the halogenated olefin resins include, but are not limited to, polyvinyl chloride. Specific examples of the polyester resins include, but are not limited to, polyethylene terephthalate resins and polybutylene terephthalate resins.

The resin layer optionally includes a particulate conductive material. Specific examples of the particulate conductive materials include, but are not limited to, metal powders, carbon blacks, titanium oxides, tin oxides, and zinc oxides. The particulate conductive material preferably has an average particle diameter of not greater than 1 μm. When the average particle diameter is too small, it is difficult to control the electrical resistance of the carrier.

The resin layer can be formed by, for example, dissolving a silicone resin, etc. in an organic solvent to prepare a resin layer constituent liquid, and then the resin layer constituent liquid is uniformly coated on the core by known methods such as dip coating, spray coating, brush coating, etc. The coated core is then subjected to drying and baking.

Specific examples of the organic solvents include toluene, xylene, methyl ethyl ketone, methyl isobutyl ketone, and cellosolve butyl acetate, but are not limited thereto.

The baking method can be either or both of an external heating method or an internal heating method. Specific baking methods include methods using a fixed electric furnace, a portable electric furnace, a rotary electric furnace, a burner furnace, and a microwave, but are not limited thereto.

The carrier preferably includes the resin layer in an amount of from 0.01 to 5.0% by weight. When the amount is too small, the resin layer cannot be uniformly formed on the surface of the core. When the amount is too large, the carrier has too thick a resin layer and therefore each of the carrier particles tend to aggregate. In this case, uneven carrier particles are obtained.

The two-component developer preferably includes the carrier in an amount of from 90 to 98% by weight, and more preferably from 93 to 97% by weight.

### Image Forming Method

The image forming method of the present invention includes:

forming an electrostatic latent image on an image bearing member (i.e., electrostatic latent image forming process);

developing the electrostatic latent image with a developer including a toner to form a toner image on the image bearing member (i.e., developing process);

transferring the toner image onto a transfer material (i.e., transfer process); and

fixing the toner image on a recording medium (i. e., fixing process), and optionally includes a discharging process, a cleaning process, a recycling process, a controlling process, etc.

The image forming apparatus of the present invention includes:

an electrostatic latent image bearing member;

an electrostatic latent image forming device configured to form an electrostatic latent image on the electrostatic latent image bearing member;

a developing device configured to develop the electrostatic latent image with a toner to form a toner image;

a transfer device configured to transfer the toner image onto a recording medium; and

a fixing device configured to fix the transferred image onto the recording medium; and preferably includes a cleaning device and optionally includes other devices, such as a discharging device, a recycling device, a controlling device, etc., if desired.

The image forming method of the present invention is preferably performed using the image forming apparatus of the present invention. Namely, the electrostatic latent image forming process can be performed with the electrostatic latent image forming device, the developing process can be performed with the developing device, the transfer process can be performed with the transfer device, the fixing process can be performed with the fixing device, and the other processes can be performed with the corresponding devices.

Each of the image forming processes and image forming devices will be explained in detail below.

### (Electrostatic Latent Image Forming Process and Device)

In the electrostatic latent image forming process, an electrostatic latent image is formed on an image bearing member The image bearing member (i.e., photoreceptor) is not limited in material, shape, structure, size, etc., and any known image bearing members can be used. However, the image bearing member preferably has a cylinder shape. Specific examples of the materials used for the image bearing members include amorphous silicon and selenium (used for inorganic photoreceptors), polysilane and phthalopolymethine (used for organic photoreceptors), etc. Among these, amorphous silicon is preferably used with respect to the long life of the photoreceptor.

For example, photoreceptors having a photoconductive layer constituted of amorphous silicon may be used. Such a photoconductive layer can be formed on a support material heated to 50 to 400° C. by typical layer-forming methods such as a vacuum deposition method, a sputtering method, an ion plating method, a thermal CVD method, an optical CVD method, and a plasma CVD method. Among these methods, a plasma CVD method in which an amorphous silicon layer is formed on a support material by decomposing a raw material gas by direct current, high-frequency, or microwave glow discharge is preferable.

The electrostatic latent image is formed by irradiating the charged image bearing member with a light containing image information in an electrostatic latent image forming device.

The electrostatic latent image forming device includes a charger configured to charge the image bearing member, and a light irradiator configured to irradiate the charged image bearing member with a light containing image information on the image bearing member.

The image bearing member is charged by applying a voltage to the surface thereof by the charger. Specific examples of the chargers include known contact chargers including a member such as an electroconductive or semiconductive roller, a brush, a film, a rubber blade, etc., and non-contact chargers using corona discharge such as corotron and scorotron, etc.

The configuration of the charging member may be a roller, a magnetic brush, a fur brush, etc., and is not particularly limited. The magnetic brush-type charging member includes, for example, ferrite particles (such as Zn—Cu ferrites), a non-magnetic conductive sleeve supporting the ferrite particles, and a magnet roll arranged in the non-magnetic conductive sleeve. The fur brush-type charging member includes, for example, charging members in which a fur treated with a carbon, copper sulfide, a metal, or a metal oxide to have conductivity is wound around or attached to a metal or a cored bar treated to have conductivity.

Among these, the contact chargers are preferably used, because these chargers produce less ozone.

The light irradiator irradiates the surface of the charged image bearing member with a light containing image information. Specific examples of the light irradiators include an emit optical irradiator, a rod lens array irradiator, a laser optical irradiator, a liquid crystal shutter irradiator, etc.

In the present invention, the image bearing member can be irradiated from the back side thereof.

### (Developing Process and Device)

In the developing process, the electrostatic latent image is developed with the toner or the developer of the present invention to form a toner image on the image bearing member. The toner image is formed with a developing device.

Suitable developing devices include any known developing devices which can use the toner or the developer of the present invention, and are not particularly limited. For example, a developing device containing the toner or the developer of the present invention, and capable of directly or indirectly adhering the toner or the developer to the electrostatic latent image is preferably used.

In the developing device, the toner and the carrier are mixed and agitated. The toner is charged by the agitation, and held in a magnetic brush which is formed on the surface of a rotating magnetic roller. Because the magnetic roller is arranged near the image bearing member (photoreceptor), a part of the toner held in the magnetic brush, which is formed on the surface of the rotating magnetic roller, is moved to the surface of the image bearing member (photoreceptor) due to the electric force. Namely, the electrostatic latent image is developed with the toner to form a toner image on the image bearing member.

### (Transfer Process and Device)

In the transfer process, the toner image is transferred onto a recording medium. It is preferable that the toner image is firstly transferred onto an intermediate transfer medium, and then secondly transferred onto the recording medium. It is more preferable that the toner image is a multiple toner image which is formed with two or more full-color toners, and the multiple toner image is firstly transferred onto the intermediate transfer medium (i.e., primary transfer process), and then secondly transferred onto the recording medium (i.e., secondary transfer process). As the intermediate transfer medium, any known transfer media can be used. In particular, an endless transfer belt is preferably used.

The transfer device (the primary transfer device and the secondary transfer device) preferably includes a transfer device configured to attract the toner image from the image bearing member (photoreceptor) to the recording medium. The number of transfer devices can be one or more.

Specific examples of the transfer devices include a corona transfer device, a transfer belt, a transfer roller, a pressure transfer roller, an adhesion transfer member, etc.

Any known recording media (e.g., recoding papers), such as plain paper and PET sheet used for OHP (overhead projector) can be used as the recording media, and are not particularly limited.

### (Fixing Process and Device)

In the fixing process, the toner image transferred onto the recording medium is fixed with a fixing device. The toner image can be fixed every time after each of toner image is transferred onto the recording medium one by one. Of course, the toner image can be fixed after all of the toner images are transferred and superimposed on the recording medium.

As the fixing device, heat pressing devices are preferably used, but are not limited thereto. The heat pressing device typically includes a combination of a heat roller and a pressing roller; and a combination of a heat roller, a pressing roller, and an endless belt; etc.

Heating temperature of the heat pressing device is preferably from 80 to 200° C.

### (Discharging Process and Device)

In the discharging process, a discharging bias is applied to the electrostatic latent image bearing member so as to remove the charge therefrom with the discharging device.

As the discharging device, any known discharging devices which can apply a discharging bias to the electrostatic latent image bearing member can be used, and is not particularly limited. For example, a discharging lamp is preferably used.

### (Cleaning Process and Device)

In the cleaning process, residual toner particles remaining on the electrostatic latent image bearing member are removed with a cleaning device.

As the cleaning device, any known cleaning devices which can remove residual toner particles from the electrostatic latent image bearing member can be used, and is not particularly limited. Specific examples of usable cleaning devices include, but are not limited to, a magnetic brush cleaner, an electrostatic brush cleaner, a magnetic roller cleaner, a blade cleaner, a web cleaner, etc.

### (Recycle Process and Device)

In the recycling process, the toner particles removed with the cleaning device are collected and transported to the developing device with a recycling device.

As the recycling device, any known transport device can be used, and is not particularly limited.

### (Controlling Process and Device)

In the controlling process, each image forming process is controlled with a controlling device.

Specific examples of the controlling device include sequencers, computers, etc., but are not limited thereto.

### Process Cartridge

The process cartridge of the present invention is detachably attached to an image forming apparatus such as a facsimile and a printer.

The process cartridge of the present invention includes a developing means containing the toner of the present invention and at least one member selected from a photoreceptor, a charging means, and a cleaning means.

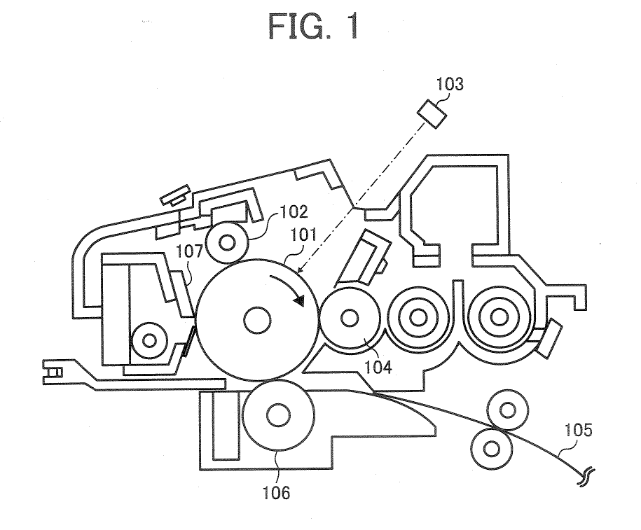

FIG. 1 is a schematic view illustrating an embodiment of the process cartridge of the present invention.

A process cartridge illustrated in FIG. 1 includes a photoreceptor 101, a charger 102, a developing means 104, a transfer means 106, and a cleaning means 107. In FIG. 1, a numeral 103 represents a light beam emitted by a light irradiator (not shown) and a numeral 105 represents a recording medium.

Photoreceptors used for the image forming apparatus of the present invention (to be explained later) can be used for the photoreceptor 101. Any known charging member can be used for the charger 102.

Next, an image forming process of the process cartridge illustrated in FIG. 1 will be explained.

The photoreceptor 101 is charged by the charger 102 and then irradiated with the light beam 103 emitted by the light irradiator (not shown) while rotating in the direction indicated by an arrow so that an electrostatic latent image is formed thereon. The electrostatic latent image is developed by the developing means 104 to form a toner image, and then the toner image is transferred onto the recording medium 105 by the transfer means 106. The surface of the photoreceptor 101 is cleaned with the cleaning means 107 after the toner image is transferred, and then discharged by a discharging means (not shown). This image forming operation is repeatedly performed.

### Image Forming Apparatus

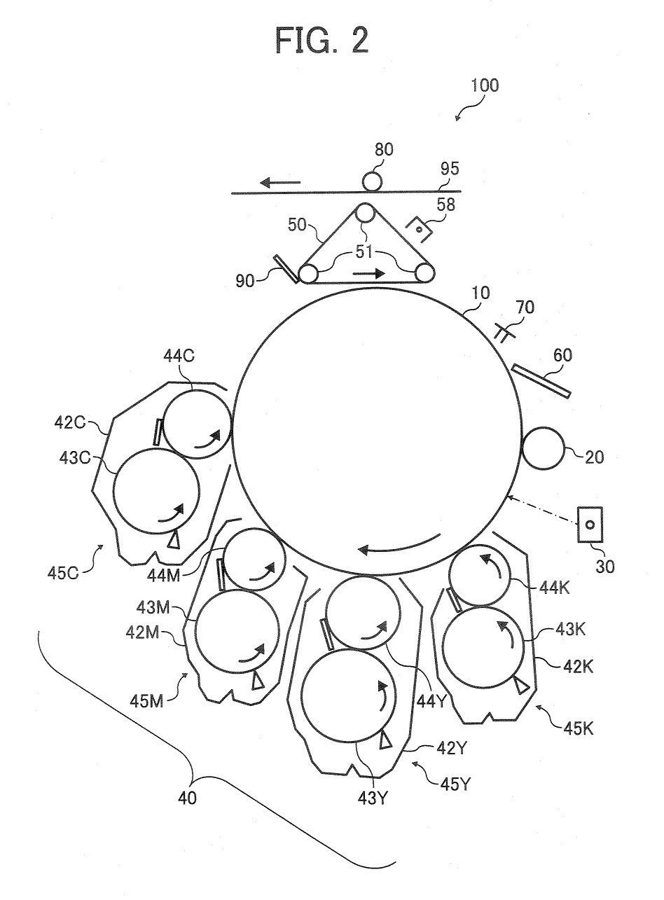

FIG. 2 is a schematic view illustrating an embodiment of the image forming apparatus of the present invention.

An image forming apparatus 100 includes a photoreceptor 10 serving as the image bearing member, a charging roller 20 serving as the charging device, a light irradiator 30 serving as the irradiating device, a developing device 40 serving as the developing device, an intermediate transfer medium 50, a cleaning device 60 including a cleaning blade serving as the cleaning device, and a discharging lamp 70 serving as the discharging device.

The intermediate transfer medium 50 is an endless belt. The intermediate transfer medium 50 is tightly stretched with three rollers 51 to move endlessly in the direction indicated by an arrow. Some of the rollers 51 have a function of applying a transfer bias (primary transfer bias) to the intermediate transfer medium 50. A cleaning device 90 including a cleaning blade is arranged close to the intermediate transfer medium 50. A transfer roller 80 is arranged facing the intermediate transfer medium 50. The transfer roller 80 can apply a transfer bias to a transfer paper 95, serving as a final transfer material, to transfer (i.e., secondary transfer) atoner image. A corona charger 58 configured to charge the toner image on the intermediate transfer medium 50 is arranged on a downstream side from a contact point of the photoreceptor 10 and the intermediate transfer medium 50, and a upstream side from a contact point of the intermediate transfer medium 50 and the transfer paper 95, relative to the rotating direction of the intermediate transfer medium 50.

The developing device 40 includes a black developing unit 45K, a yellow developing unit 45Y, a magenta developing unit 45M and a cyan developing unit 45C, arranged around the photoreceptor 10. The developing units 45K, 45Y, 45M and 45C include developer containers 42K, 42Y, 42M and 42C, developer feeding rollers 43K, 43Y, 43M and 43C, and developing rollers 44K, 44Y, 44M and 44C, respectively.

In the image forming apparatus 100, the photoreceptor 10 is uniformly charged by the charging roller 20, and then the light irradiator 30 irradiates the photoreceptor 10 with a light containing image information to form an electrostatic latent image thereon. The electrostatic latent image formed on the photoreceptor 10 is developed with a toner supplied from the developing device 40, to form a toner image. The toner image is transferred onto the intermediate transfer medium 50 due to a bias applied to a roller 51 (i.e., primary transfer), and then transferred onto the transfer paper 95 (i.e., secondary transfer) Toner particles remaining on the photoreceptor 10 are removed using the cleaning device 60, and the photoreceptor 10 is once discharged by the discharging lamp 70.

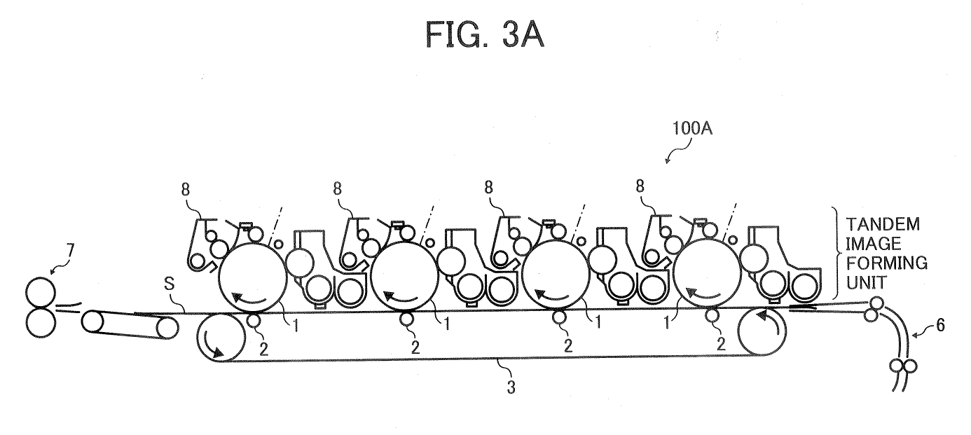

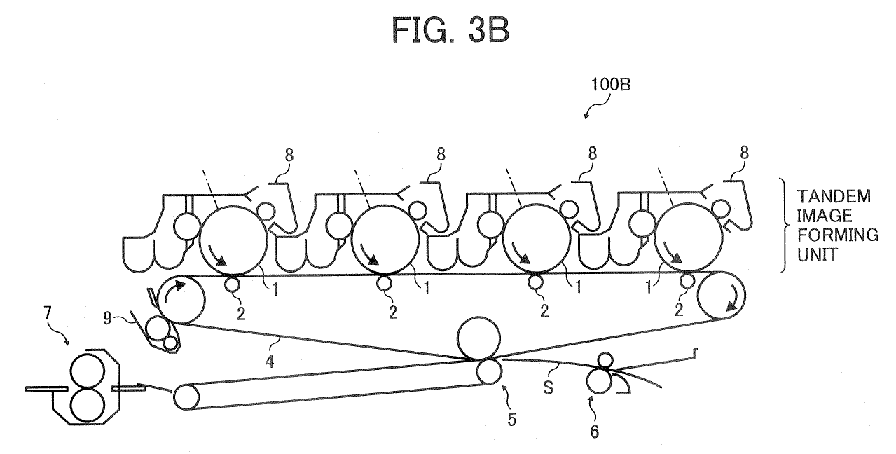

FIGS. 3A and 3B are schematic views illustrating another embodiments of the image forming apparatus of the present invention.

Image forming apparatuses 100A and 100B are tandem image forming apparatuses each adopting a direct transfer method and an indirect transfer method, respectively. The same reference numbers shown in FIGS. 3A and 3B represent the same component.

The image forming apparatus 100A includes a plurality of photoreceptors 1, a plurality of transfer devices 2, a sheet transport belt 3, a paper feeding device 6, a fixing device 7, and a plurality of photoreceptor cleaning devices 8.

The image forming apparatus 100B includes a plurality of photoreceptors 1, a plurality of primary transfer devices 2, an intermediate transfer medium 4, a secondary transfer device 5, a paper feeding device 6, a fixing device 7, a plurality of photoreceptor cleaning devices 8, and an intermediate transfer medium cleaning device 9.

In the tandem image forming apparatus 100A adopting a direct transfer method, each of toner images formed on each of the photoreceptors 1 is transferred one after another onto a transfer sheet S, transported by the sheet transport belt 3, by each of the transfer devices 2.

In the tandem image forming apparatus 100B adopting an indirect transfer method, each of toner images formed on each of the photoreceptors 1 is transferred one after another onto the intermediate transfer medium 4 by each of the primary transfer devices 2, and then the transferred toner images are transferred all together onto a transfer sheet S by the secondary transfer device 5. In this embodiment, the secondary transfer device includes a belt-shaped transfer medium (i.e., a transfer transport belt). Alternatively, the secondary transfer device may include a cylindrical (roller-shaped) transfer medium.

In FIG. 3A, the paper feeding device 6 and the fixing device 7 need to be arranged on the upstream side and the downstream side, respectively, of the tandem image forming unit. Therefore, there is a drawback that the machine becomes larger in size in a direction in which the sheet S is transported.

In contrast, in FIG. 3B, the paper feeding device 6 and the fixing device 7 may be arranged immediately below (or above) the tandem image forming unit. Therefore, there is an advantage that the machine becomes smaller in size.

Further, in FIG. 3A, the fixing device 7 may be arranged as close as possible to the tandem image forming unit, in order that the machine does not become larger in size in a direction in which the sheet S is transported. In this case, there is no sufficient space where the sheet S can bend before entering into the fixing device 7. Therefore, there is a drawback that the image forming operation performed on the upstream side of the fixing device 7 is influenced by an impact of the entering tip of the sheet S (particularly thick sheet) into the fixing device 7 and the difference in sheet transport speed between the fixing device 7 and the transfer transport belt.

In contrast, in FIG. 3B, there is a sufficient space where the sheet S can bend before entering into the fixing device 7. Therefore, the image forming operation performed on the upstream side of the fixing device 7 is hardly influenced by the fixing device 7.

Because of the above reasons, tandem image forming apparatuses adopting an indirect transfer method attract attention recently.

As illustrated in FIGS. 3A and 3B, each of the tandem image forming apparatuses 100A and 100B includes a plurality of the photoreceptor cleaning devices 8. Toner particles remaining on the photoreceptors 1 after the (primary) transfer are removed with the photoreceptor cleaning devices 8 so as to clean the surfaces of the photoreceptors 1 and prepare for the next image forming operation. Further, the tandem image forming apparatus 100B includes an intermediate transfer medium cleaning device 9. Toner particles remaining on the intermediate transfer medium 4 after the secondary transfer are removed with the intermediate transfer medium cleaning device 9 so as to clean the surface of the intermediate transfer medium 4 and prepare for the next image forming operation.

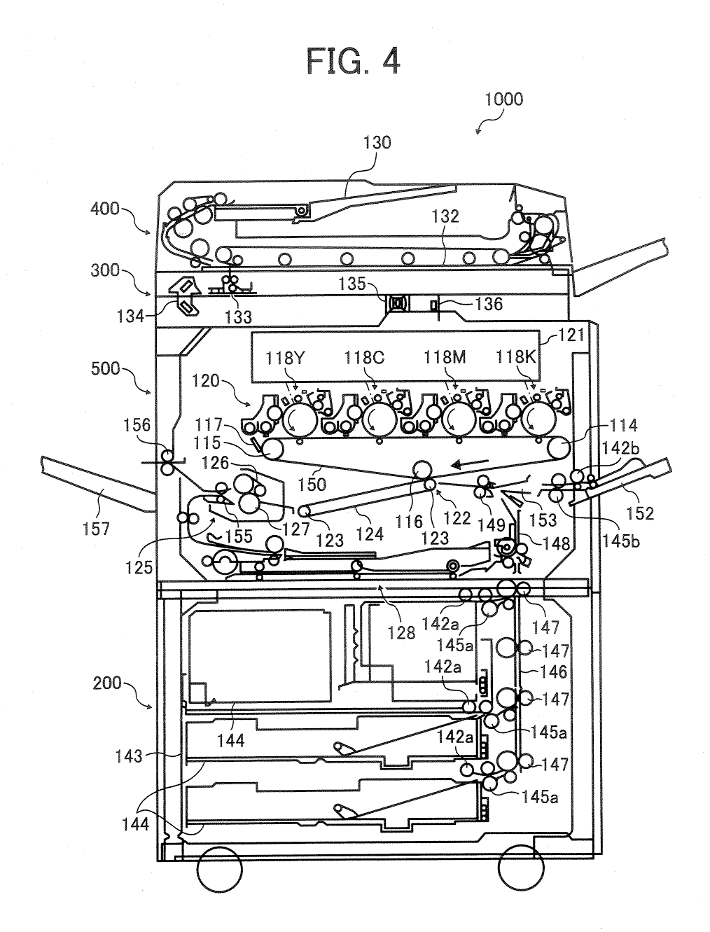

FIG. 4 is a schematic view illustrating another embodiment of the image forming apparatus of the present invention. The image forming apparatus 1000 is a tandem color image forming apparatus. The image forming apparatus 1000 includes a main body 500, a paper feeding table 200, a scanner 300 and an automatic document feeder (ADF) 400.

An intermediate transfer medium 150 is arranged in the center of the main body 500. The intermediate transfer medium 150, which is an endless belt, is tightly stretched with support rollers 114, 115 and 116 to rotate in a clockwise direction. A cleaning device 117, configured to remove residual toner particles remaining on the intermediate transfer medium 150, is arranged close to the support roller 115. A tandem-type image forming device 120 including image forming units 118Y, 118C, 118M and 118K is arranged facing the intermediate transfer medium 150. The image forming units 118Y, 118C, 118M and 118K are arranged in this order around the intermediate transfer medium 150 relative to the rotating direction thereof.

A light irradiator 121 is arranged close to the tandem-type image forming device 120. A secondary transfer device 122 is arranged on the opposite side of the intermediate transfer medium 150 relative to the tandem-type image forming device 120. The secondary transfer device 122 includes a secondary transfer belt 124, which is an endless belt, tightly stretched with a pair of rollers 123. A transfer paper transported on the secondary transfer belt 124 can contact the intermediate transfer medium 150. A fixing device 125 is arranged close to the secondary transfer device 122.

A reversing device 128 configured to reverse a transfer paper to form images on both sides of the transfer paper is arranged close to the secondary transfer device 122 and the fixing device 125. The fixing device 125 includes a fixing belt 126 and a pressing roller 127 configured to press the fixing belt 126.

Next, a procedure of forming a full color image with the image forming apparatus 1000 will be explained. An original document is set to a document feeder 130 included in the automatic document feeder (ADF) 400, or placed on a contact glass 132, included in the scanner 300.

When a start switch button (not shown) is pushed, the scanner 300 starts driving, and a first runner 133 and a second runner 134 start moving. When the original document is set to the document feeder 130, the scanner 300 starts driving after the original document is fed on the contact glass 132. The original document is irradiated with a light emitted by a light source via the first runner 133, and the light reflected from the original document is then reflected by a mirror included in the second runner 134. The light passes through an imaging lens 135 and is received by a reading sensor 136. Thus, image information of each color is read. Each color image information is transmitted to the image forming units 118Y, 118C, 118M and 118K, respectively, to form each color toner image.

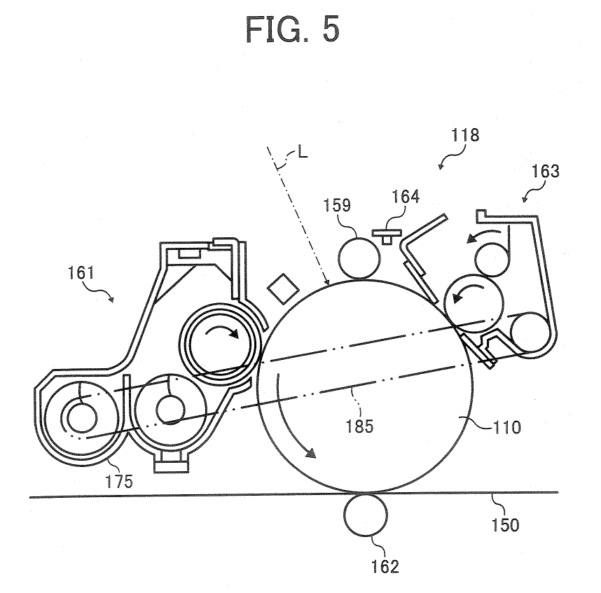

FIG. 5 is a schematic view illustrating an embodiment of the image forming units 118Y, 118C, 118M and 118K. Since the image forming units 118Y, 118C, 118M and 118K have the same configuration, only one image forming unit is illustrated in FIG. 5. Symbols Y, C, M and K, which represent each of the colors, are omitted from the reference number.

The image forming unit 118 includes a photoreceptor 110, a charger 159 configured to uniformly charge the photoreceptor 110, a light irradiator (not shown) configured to form an electrostatic latent image on the photoreceptor 110 by irradiating a light L containing image information corresponding to color information, a developing device 161 configured to form a toner image by developing the electrostatic latent image with a developer including a toner, a transfer charger 162 configured to transfer the toner image to the intermediate transfer medium 150, a cleaning device 163, and a discharging device 164.

A black toner image formed on a black photoreceptor 10K, a yellow toner image formed on a yellow photoreceptor 10Y, a magenta toner image formed on a magenta photoreceptor 10M, and a cyan toner image formed on a cyan photoreceptor 10C are independently transferred (i.e., primary transfer) onto the intermediate transfer medium 150 and superimposed thereon so that a full-color toner image is formed.

On the other hand, in the paper feeding table 200, a recording paper is fed from one of multistage paper feeding cassettes 144, included in a paper bank 143, by rotating one of paper feeding rollers 142a. The recording paper is separated by separation rollers 145a and fed to a paper feeding path 146. Then the recording paper is transported to a paper feeding path 148, included in the main body 500, by transport rollers 147, and is stopped by a registration roller 149. When the recording paper is fed from a manual paper feeder 152 by rotating a paper feeding roller 142b, the recording paper is separated by a separation roller 145b and fed to a manual paper feeding path 153, and is stopped by the registration roller 149. The registration roller 149 is typically grounded, however, a bias can be applied thereto in order to remove a paper powder.

The recording paper is timely fed to an area formed between the intermediate transfer medium 150 and the secondary transfer device 122, by rotating the registration roller 149, to meet the full-color toner image formed on the intermediate transfer medium 150. The full-color toner image is transferred onto the recording material in the secondary transfer device 122 (secondary transfer). Toner particles remaining on the intermediate transfer medium 150 are removed with the cleaning device 117.

The recording paper having the toner image thereon is transported from the secondary transfer device 122 to the fixing device 125. The toner image is fixed on the recording paper upon application of heat and pressure thereto in the fixing device 125. The recording paper is switched by a switch pick 155 and ejected by an ejection roller 156 and then stacked on an ejection tray 157. When the recording paper is switched by the switch pick 155 to be reversed in the reverse device 128, the recording paper is fed to a transfer area again in order to form a toner image on the backside thereof. And then the recording paper is ejected by the ejection roller 156 and stacked on the ejection tray 157.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Preparation of Pre-Toner

### Preparation of Particulate Resin

In a reaction vessel equipped with a stirrer and a thermometer, 683 parts of water, 11 parts of a sodium salt of sulfate of an ethylene oxide adduct of methacrylic acid (ELEMINOL RS-30 from Sanyo Chemical Industries Ltd.), 83 parts of styrene, 83 parts of methacrylic acid, 110 parts of butyl acrylate, and 1 part of ammonium persulfate are contained and the mixture is agitated with the stirrer for 15 minutes at a revolution of 400 rpm. As a result, a milky emulsion is prepared. Then the emulsion is heated to 75° C. to react the monomers for 5 hours.

Further, 30 parts of a 1% aqueous solution of ammonium persulfate are added thereto, and the mixture is aged for 5 hours at 75° C. Thus, an aqueous dispersion (1) (i.e., particle dispersion (1)) of a vinyl resin (1) (i.e., a copolymer of styrene/methacrylic acid/butyl acrylate/sodium salt of sulfate of ethylene oxide adduct of methacrylic acid) is prepared.

The particulate vinyl resin (1) has a volume average particle diameter of 105 nm, which is determined by a particle size distribution analyzer LA-920 (manufactured by Horiba, Ltd.) A part of the particle dispersion is dried to isolate the resin. The vinyl resin (1) has a glass transition temperature (Tg) of 59° C. and a weight average molecular weight (Mw) of 150,000.

### Preparation of Water Phase

990 parts of water, 83 parts of the particle dispersion (1) prepared above, 37 parts of an aqueous solution of a sodium salt of dodecyl diphenyl ether disulfonic acid (ELEMINOL MON-7 from Sanyo Chemical Industries Ltd., solid content of 48.5%), and 90 parts of ethyl acetate are mixed. As a result, a water phase (1) is prepared.

### Preparation of Low-Molecular-Weight Polyester

The following components are fed in a reaction vessel equipped with a condenser, a stirrer and a nitrogen feed pipe.

| | |
|---|---|
| Ethylene oxide (2 mole) adduct of bisphenol A | 229 parts |
| Propylene oxide (3 mole) adduct of bisphenol A | 529 parts |
| Terephthalic acid | 208 parts |
| Adipic acid | 46 parts |
| Dibutyltin oxide | 2 parts |

The mixture is reacted for 8 hours at 230° C. under normal pressure.

Then the reaction is further continued for 5 hours under a reduced pressure of 10 to 15 mmHg.

Further, 44 parts of trimellitic anhydride is fed to the container to be reacted with the reaction product for 2 hours at 180° C. Thus, a low-molecular-weight polyester (1) is prepared.

The low-molecular-weight polyester (1) has a number average molecular weight (Mn) of 2,500, a weight average molecular weight (Mw) of 6,700, a glass transition temperature (Tg) of 43° C., and an acid value of 25 mgKOH/g.

### Preparation of Prepolymer

The following components are fed in a reaction vessel equipped with a condenser, a stirrer and a nitrogen feed pipe.

| | |
|---|---|
| Ethylene oxide (2 mole) adduct of bisphenol A | 682 parts |
| Propylene oxide (2 mole) adduct of bisphenol A | 81 parts |
| Terephthalic acid | 283 parts |
| Trimellitic anhydride | 22 parts |
| Dibutyl tin oxide | 2 parts |

The mixture is reacted for 8 hours at 230° C. under normal pressure.

Then the reaction is further continued for 5 hours under a reduced pressure of 10 to 15 mmHg. Thus, an intermediate polyester (1) is prepared.

The intermediate polyester (1) has a number average molecular weight (Mn) of 2,100, a weight average molecular weight (Mw) of 9,500, a glass transition temperature (Tg) of 55° C., an acid value of 0.5 mgKOH/g, and a hydroxyl value of 51 mgKOH/g.

In a reaction vessel equipped with a condenser, a stirrer and a nitrogen feed pipe, 410 parts of the intermediate polyester (1), 89 parts of isophorone diisocyanate, and 500 parts of ethyl acetate are mixed and the mixture is heated for 5 hours at 100° C. to perform the reaction. Thus, a polyester prepolymer (1) having an isocyanate group is prepared. The content of free isocyanate in the prepolymer (1) is 1.53% by weight.

### Synthesis of Ketimine

In a reaction vessel equipped with a stirrer and a thermometer, 170 parts of isophorone diamine and 75 parts of methyl ethyl ketone are mixed and reacted for 5 hours at 50° C. to prepare a ketimine compound (1). The ketimine compound (1) has an amine value of 418 mgKOH/g.

### Preparation of Master Batch

The following components are mixed with a HENSCHEL MIXER (manufactured by Mitsui Mining Co., Ltd.).

| | |
|---|---|
| Water | 35 parts |
| Phthalocyanine pigment | 40 parts |
| (FG7351 from Toyo Ink Mfg. Co., Ltd.) | |
| Polyester resin | 60 parts |
| (RS801 from Sanyo Chemical Industries Ltd.) | |

The mixture is kneaded for 30 minutes at 150° C. with a two-roll mill, and then subjected to rolling and cooling. The rolled mixture is pulverized using a pulverizer. Thus, a master batch (1) is prepared.

### Preparation of Wax/Colorant Dispersion

In a vessel equipped with a stirrer and a thermometer, 378 parts of the low-molecular-weight polyester (1), 110 parts of a carnauba wax, 22 parts of a charge controlling agent (a metal complex of salicylic acid E-84 from Orient Chemical Industries, Ltd.), and 947 parts of ethyl acetate are contained. The mixture is heated to 80° C. for 5 hours while agitated, and then cooled to 30° C. over a period of 1 hour. Further, 500 parts of the master batch (1) and 500 parts of ethyl acetate are added thereto and agitated for 1 hour to prepare a raw material dispersion (1).

Then 1324 parts of the raw material dispersion (1) is subjected to a dispersion treatment using a bead mill (ULTRAVISCOMILL (trademark) from Aimex Co., Ltd.) The dispersing conditions are as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Then 1324 parts of a 65% ethyl acetate solution of the low-molecular-weight polyester (1) are added thereto. The mixture is subjected to the dispersion treatment using the bead mill. The dispersion conditions are the same as those mentioned above except that the dispersion operation is performed once (i.e., one pass).

Thus, a wax/colorant dispersion (1) is prepared. A solid content of the wax/colorant dispersion (1) is 50% by weight (when the liquid is heated for 30 minutes at 130° C.).

### Emulsification

In a vessel, 648 parts of the wax/colorant dispersion (1), 154 parts of the prepolymer (1), and 6.6 parts of the ketimine compound (1) are contained and agitated for 1 minute at a revolution of 5,000 rpm using a TK HOMOMIXER (from Tokushu Kika Kogyo K.K.). Next, 1200 parts of the water phase (1) are added thereto. The mixture is agitated for 20 minutes at a revolution of 13,000 rpm using a TK HOMOMIXER. As a result, an emulsion slurry (1) is prepared.

### Shape Control

A proper amount of ion-exchange water, a surfactant, and a viscosity improver are contained in a vessel and mixed to prepare a water solution. The emulsion slurry (1) is added thereto, and then the mixture is agitated for 1 hour at a revolution of 2,000 rpm using a TK HOMOMIXER (from Tokushu Kika Kogyo K.K.) Thus, a shape-controlled slurry (1) is prepared.

### Solvent Removal

The shape-controlled slurry (1) is fed into a reaction vessel equipped with a stirrer and a thermometer, and then heated for 8 hours at 30° C. to remove the organic solvent (ethyl acetate) therefrom. Then the shape-controlled slurry (1) is aged for 4 hours at 45° C. Thus, a dispersion slurry (1) is prepared.

### Washing and Drying

One hundred (100) parts of the dispersion slurry (1) is filtered under a reduced pressure.

The thus obtained wet cake is mixed with 100 parts of ion-exchange water and the mixture is agitated for 10 minutes with a TK HOMOMIXER at a revolution of 12,000 rpm, followed by filtering. Thus, a wet cake (i) is prepared.

The wet cake (i) is mixed with 100 parts of a 10% aqueous solution of sodium hydroxide and the mixture is agitated for 30 minutes with a TK HOMOMIXER at a revolution of 12,000 rpm, followed by filtering under a reduced pressure. Thus, a wet cake (ii) is prepared.

The wet cake (ii) is mixed with 100 parts of a 10% aqueous solution of hydrochloric acid and the mixture is agitated for 10 minutes with a TK HOMOMIXER at a revolution of 12,000 rpm, followed by filtering. Thus, a wet cake (iii) is prepared.

The wet cake (iii) is mixed with 300 parts of ion-exchange water and the mixture is agitated for 10 minutes with a TK HOMOMIXER at a revolution of 12,000 rpm, followed by filtering. This operation is performed twice. Thus, a wet cake (iv) is prepared.

The wet cake (iv) is dried for 48 hours at 45° C. using a circulating air drier, followed by sieving with a screen having openings of 75 μm. Thus, a mother toner (1) is prepared.

### External Treatment

One hundred (100) parts of the prepared mother toner (1) are mixed with 0.8 parts of a hydrophobized titanium oxide treated with isobutyl and having an average particle diameter of 15 nm and 1.0 part of a hydrophobized silica treated with hexamethyldisilazane and having an average particle diameter of 12 nm using a HENSHEL MIXER (manufactured by Mitsui Mining Co., Ltd.) at a peripheral speed of the agitation blade of 20 m/s. Thus, a pre-toner (1) is prepared.

### Preparation of Carrier

At first, 200 parts of a silicone resin solution (from Shin-Etsu Chemical Co., Ltd.) and 3 parts of a carbon black (from Cabot Japan K.K.) are dissolved or dispersed in toluene to prepare a coating liquid. The coating liquid is coated on 2,500 parts of a ferrite core by a fluidized-bed spraying method to form a cover layer thereon. The coated ferrite is calcined in an electric furnace for 2 hours at 300° C. Thus, a carrier (1) covered with a silicone resin is prepared.

### Example 1

An aqueous solution in which 5 g of a polyvinyl alcohol (KURARAY POVAL 205 from Kuraray Co., Ltd.) is dissolved in 555 g of water is mixed with a mixture including 184 g of methyl methacrylate, 16 g of trimethylolpropane trimethacrylate, 1 g of lauryl peroxide, 100 g of methyl isobutyl ketone, and 2 g of a butyl methacrylate resin at a revolution of 1,000 rpm using a TK HOMOMIXER, to prepare a dispersion of a monomer mixture. The thus prepared dispersion is contained in a four-neck flask equipped with a stirrer, a condenser, a thermometer, and a nitrogen inlet pipe, and then heated for 3 hours at 60° C. while agitated under nitrogen gas airflow, to prepare a suspension liquid. The suspension liquid is cooled to room temperature, and then filtered and washed with water. The filtered cake is dried for 24 hours at 110° C. Thus, particulate porous cross-linked resin (A) is prepared.

The particulate porous cross-linked resin (A) has a volume average particle diameter of 29 μm determined by COULTER MULTISIZER II (manufactured by Coulter Electrons Inc.), a specific surface area of 14 m²/g determined by nitrogen multipoint BET method, a total volume of pores of 0.05 cc/g determined by mercury intrusion porosimetry, and diameters of the pores of from 0.15 to 2.0 μm determined by SEM observation.

The particulate porous cross-linked resin (A) is mixed with the pre-toner (1) so that the mixture includes the particulate porous cross-linked resin (A) in an amount of 1.0% by weight. Then the mixture is sieved with a 795 mesh to remove the particulate porous cross-linked resin (A). Thus, a toner (1) is prepared.

### Example 2

The procedure for preparation of the particulate porous cross-linked resin (A) in Example 1 is repeated except that the revolution of the TK HOMOMIXER is changed. Thus, the particulate porous cross-linked resin (B) is prepared.

The particulate porous cross-linked resin (B) has a volume average particle diameter of 38.0 μm determined by COULTER MULTISIZER II (manufactured by Coulter Electrons Inc.), a specific surface area of 10 m²/g determined by nitrogen multipoint BET method, a total volume of pores of 0.06 cc/g determined by mercury intrusion porosimetry, and diameters of the pores of from 0.15 to 2.0 μm determined by SEM observation.

The particulate porous cross-linked resin (B) is mixed with the pre-toner (1) so that the mixture includes the particulate porous cross-linked resin (B) in an amount of 1.0% by weight. Then the mixture is sieved with a 795 mesh to remove the particulate porous cross-linked resin (B). Thus, a toner (2) is prepared.

### Example 3

### Preparation of Master Batch

The following components are mixed with a HENSCHEL MIXER (manufactured by Mitsui Mining Co., Ltd.).

| | |
|---|---|
| Water | 1200 parts |
| Carbon black | 540 parts |
| (PRINTEX 35 from Degussa AG, having DBP | |
| absorption value of 42 ml/100 mg and pH of 9.5) | |
| Low-molecular-weight polyester (1) | 1200 parts |

The mixture is kneaded for 30 minutes at 150° C. with a two-roll mill, and then subjected to rolling and cooling. The rolled mixture is pulverized using a pulverizer (manufactured by Hosokawa Micron Corporation) Thus, a master batch (2) is prepared.

### Preparation of Toner Constituent Dispersion

In a vessel equipped with a stirrer and a thermometer, 378 parts of the low-molecular-weight polyester (1), 110 parts of a carnauba wax, 22 parts of a charge controlling agent (a metal complex of salicylic acid E-84 from Orient Chemical Industries, Ltd.), and 947 parts of ethyl acetate are contained. The mixture is heated to 80° C. for 5 hours while agitated, and then cooled to 30° C. over a period of 1 hour. Further, 500 parts of the master batch (2) and 500 parts of ethyl acetate are added thereto and agitated for 1 hour to prepare a raw material dispersion (2).

Then 1324 parts of the raw material dispersion (2) is subjected to a dispersion treatment using a bead mill (ULTRAVISCOMILL (trademark) from Aimex Co., Ltd.). The dispersing conditions are as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Then 1324 parts of a 65% ethyl acetate solution of the low-molecular-weight polyester (1) are added thereto. The mixture is subjected to the dispersion treatment using the bead mill. The dispersion conditions are the same as those mentioned above except that the dispersion operation is performed once (i.e., one pass).

Next, 3 parts of a layered inorganic compound montmorillonite partially modified with a quaternary ammonium slat having a benzyl group (CLAYTON® APA from Southern Clay Products, Inc.) is added to 2,000 parts of the above mixture, and then agitated for 30 minutes using a TK HOMOMIXER (from Tokushu Kika Kogyo K.K.).

Thus, a toner constituent dispersion is prepared.

The toner constituent dispersion is subjected to a measurement of viscosity as follows. A rheometer AR2000 (from TA Instruments Japan) equipped with a pair of parallel plates having a diameter of 20 mm is adjusted to have a gap of 30 μm. The viscosity (A) is measured after a shear is applied to a sample for 30 seconds at a shear rate of 1/30,000 (1/s) and then the shear rate is changed from 0 to 1/70 (1/s) over a period of 20 seconds at 25° C. The viscosity (B) is measured after a shear is applied to a sample for 30 seconds at a shear rate of 1/30,000 (1/s) at 25° C.

### Preparation of Oil Phase Mixture Liquid

In a reaction vessel, 749 parts of the toner constituent dispersion, 115 parts of the prepolymer (1), and 2.9 parts of the ketimine compound are contained, and then agitated for 1 minute using a TK HOMOMIXER (from Tokushu Kika Kogyo K.K.) at a revolution of 5,000 rpm.

Thus, an oil phase mixture liquid is prepared.

### Preparation of Water Phase

990 parts of water, 83 parts of the particulate resin dispersion, 37 parts of a 48.5% by weight aqueous solution of a sodium salt of dodecyl diphenyl ether disulfonic acid (ELEMINOL MON-7 from Sanyo Chemical Industries Ltd.), 135 parts of a 1% by weight aqueous solution of a polymer dispersant carboxymethylcellulose sodium (CELLOGEN® BS-H-3 from Dai-ichi Kogyo Seiyaku Co., Ltd.), and 90 parts of ethyl acetate were mixed. As a result, a water phase (2) was prepared.

### Emulsification

In 1200 parts of the water phase (2), 867 parts of the oil phase mixture liquid are adedd. The mixture is agitated for 20 minutes at a revolution of 13,000 rpm using a TK HOMOMIXER. As a result, an emulsion slurry (2) is prepared.

### Solvent Removal

The emulsion slurry (2) is fed into a reaction vessel equipped with a stirrer and a thermometer, and then heated for 8 hours at 30° C. to remove the organic solvent (ethyl acetate) therefrom. Then the emulsion slurry (2) is aged for 4 hours at 45° C. Thus, a dispersion slurry (2) is prepared.

### Washing and Drying

One hundred (100) parts of the dispersion slurry (2) is filtered under a reduced pressure.

The thus obtained wet cake is mixed with 100 parts of ion-exchange water and the mixture is agitated for 10 minutes with a TK HOMOMIXER at a revolution of 12,000 rpm, followed by filtering. Thus, a wet cake (i) is prepared.

The wet cake (i) is mixed with 100 parts of a 10% aqueous solution of hydrochloric acid so that the mixture has a pH of 2.8 and the mixture is agitated for 10 minutes with a TK HOMOMIXER at a revolution of 12,000 rpm, followed by filtering. Thus, a wet cake (ii) is prepared.

The wet cake (ii) is mixed with 300 parts of ion-exchange water and the mixture is agitated for 10 minutes with a TK HOMOMIXER at a revolution of 12,000 rpm, followed by filtering. This operation is performed twice. Thus, a wet cake (iii) is prepared.

The wet cake (iii) is dried for 48 hours at 45° C. using a circulating air drier, followed by sieving with a screen having openings of 75 μm. Thus, a mother toner (2) is prepared.

### External Treatment

One hundred (100) parts of the prepared mother toner (2) are mixed with 0.8 parts of a hydrophobized titanium oxide treated with isobutyl and having an average particle diameter of 15 nm and 1.0 part of a hydrophobized silica treated with hexamethyldisilazane and having an average particle diameter of 12 nm using a HENSHEL MIXER (manufactured by Mitsui Mining Co., Ltd.) at a peripheral speed of the agitation blade of 20 m/s. Thus, a pre-toner (2) is prepared.

The particulate porous cross-linked resin (B) is mixed with the pre-toner (2) so that the mixture includes the particulate porous cross-linked resin (B) in an amount of 1.0% by weight. Then the mixture is sieved with a 795 mesh to remove the particulate porous cross-linked resin (B). Thus, a toner (3) is prepared.

### Comparative Example 1

The procedure for preparation of the particulate porous cross-linked resin (A) in Example 1 is repeated except that the revolution of the TK HOMOMIXER is changed to 11,000 rpm. Thus, the particulate porous cross-linked resin (C) is prepared.

The particulate porous cross-linked resin (C) has a volume average particle diameter of 1.20 μm determined by COULTER MULTISIZER II (manufactured by Coulter Electrons Inc.), a specific surface area of 6 m²/g determined by nitrogen multipoint BET method, a total volume of pores of 0.02 cc/g determined by mercury intrusion porosimetry, and diameters of the pores of from 0.10 to 0.8 μm determined by SEM observation.

The particulate porous cross-linked resin (C) is mixed with the pre-toner (1) so that the mixture includes the particulate porous cross-linked resin (C) in an amount of 1.0% by weight. Thus, a toner (4) is prepared.

### Comparative Example 2

The procedure for preparation of the particulate porous cross-linked resin (A) in Example 1 is repeated except that the revolution of the TK HOMOMIXER is changed to 500 rpm. Thus, the particulate porous cross-linked resin (D) is prepared.

The particulate porous cross-linked resin (C) has a volume average particle diameter of 52.0 μm determined by COULTER MULTISIZER II (manufactured by Coulter Electrons Inc.), a specific surface area of 6 m²/g determined by nitrogen multipoint BET method, a total volume of pores of 0.07 cc/g determined by mercury intrusion porosimetry, and diameters of the pores of from 0.3 to 2.0 μm determined by SEM observation.

The particulate porous cross-linked resin (D) is mixed with the pre-toner (1) so that the mixture includes the particulate porous cross-linked resin (D) in an amount of 1.0% by weight. Thus, a toner (5) is prepared.

The pre-toner (1) is used as a toner (6).

### Preparation of Developer

Five parts of each of the toners (1) to (6) and 95 parts of the carrier (1) are mixed using a TURBULA® shaker-mixer TF2 (from Willy A. Bachofen AG Maschinenfabrik) for 5 minutes. Thus, developers (1) to (6) are prepared.

### Evaluations

The image forming apparatus for use in the following evaluations of the toners prepared above will be explained.

The image forming apparatus includes a photoreceptor, a charging roller configured to uniformly charge the photoreceptor by contacting or being close to the photoreceptor, an irradiator configured to form an electrostatic latent image on the photoreceptor, a developing device configured to develop the electrostatic latent image to form a toner image, a transfer belt configured to transfer the toner image onto a transfer paper, a cleaning device configured to remove toner particles remaining on the photoreceptor, a discharging lamp configured to discharge residual charges on the photoreceptor, and a light sensor configured to control the applied voltage of the charging roller and the toner concentration in the developing device.

Each of the toners prepared in Examples and Comparative Examples is supplied to the developing device by a toner supplying device via a toner supplying opening.

The operation of the image forming apparatus is as follows. The photoreceptor rotates in a counterclockwise direction. The photoreceptor is discharged by the irradiation of a discharging light so that the surface potential is averaged from 0 to −150 V (i.e., the standard potential), and then charged by the charging roller so that the surface potential is about −1000 V. Next, the photoreceptor is irradiated with a light emitted by the irradiator so that the irradiated portion (i.e., image portion) has a surface potential of from 0 to −200 V. In the developing device, the toner present on a developing sleeve is adhered to the image portion to form a toner image. The photo receptor having the toner image thereon rotates, while a transfer paper is timely fed from a paper feeding part so that the tip of the transfer paper meets the toner image on the transfer belt. The toner image formed on the photoreceptor is transferred onto a transfer paper by the transfer belt. The transfer paper having the toner image thereon is transported to a fixing device so that the toner image is fixed on the transfer paper upon application of heat and pressure thereto, and then the resultant copy is ejected. Toner particles remaining on the photoreceptor are removed with a cleaning blade included in the cleaning device, and then residual charges of the photoreceptor are discharged by the irradiation of a discharging light. Thus, the photoreceptor prepares for the next image forming operation.

The developers (1) to (6) each are set in the above image forming apparatus and subjected to the following evaluations.

### (1) Cleanability

The following test is performed using the above image forming apparatus in an environmental testing room set to a temperature of 10° C. and a humidity of 15%. At first, 5,000 copies of a white solid image are produced. During the next white solid image is produced, the image forming operation is stopped. After the photoreceptor is cleaned by the cleaning device, toner particles remaining on the photoreceptor are transferred onto a white paper by a SCOTCH® TAPE (from Sumitomo 3M Limited), and density thereof is measured using a Macbeth reflective densitometer RD514. The cleanability is evaluated by the density difference from the blank (i.e., white paper) as follows.

Good: The density difference is less than 0.01.

Average: The density difference is 0.01 to 0.02.

Poor: The density difference is greater than 0.02.

### (2) Image Quality

At first, 5,000 copies of a white solid image are produced. Then a black solid image is produced and visually observed to evaluate whether transfer defect occurs or not.

On the other hand, after 5,000 copies of a white solid image are produced, the image forming operation is stopped during the next white solid image is developed. Toner particles remaining on the photoreceptor are transferred onto a white paper by a tape, and density thereof is measured using a spectrodensitometer X-RITE (from X-Rite) to evaluate the level of background fouling occurred. The background fouling is evaluated by the density difference from the blank (i.e., white paper) as follows:

Good: The density difference is less than 0.03.

Poor: The density difference is not less than 0.03.

Considering the above evaluation results of transfer defect and background fouling, the produced image quality is comprehensively evaluated.

### (3) Scratches on Photoreceptor

After 100,000 copies of an A4-size image having an image proportion of 4% are produced, the photoreceptor is visually observed whether scratches are made or not and evaluated as follows.

Good: No scratch or few scratches are made.

Average: A few scratches are made, but the produced image has no problem.

Poor: Abnormal images are produced, or unrecoverable scratches are made

### (4) Filming Resistance

After 1,000 copies of an image chart having strip images having an image proportion of 100%, 75%, and 50% are produced, the developing roller and the photoreceptor are visually observed whether a film of the toner components is formed or not and evaluated as follows.

Very good: No film is observed.

Good: Films are slightly observed.

Average: Streaky film is observed.

Poor: Films are observed all over the developing roller/photoreceptor.

TABLE 1

| | | Image | Scratches on | Filming |
|---|---|---|---|---|
| | Cleanability | quality | photoreceptor | resistance |
| Ex. 1 | Good | Good | Good | Very good |
| Ex. 2 | Good | Good | Good | Good |
| Ex. 3 | Good | Good | Good | Very good |
| Comp. | Good | Good | Average | Average |
| Ex. 1 | | | | |
| Comp. | Good | Average | Average | Average |
| Ex. 2 | | | | |
| Comp. | Average | Good | Poor | Poor |
| Ex. 3 | | | | |

This document claims priority and contains subject matter related to Japanese Patent Application No. 2006-142867, filed on May 23, 2006, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner, manufactured by a method comprising:
mixing a particulate porous cross-linked resin having pores on a surface thereof and a volume average particle diameter of from 25 to 50 μm with a pre-toner comprising:
a colored particulate material comprising a binder resin, a colorants and a release agent; and
an external additive; and
removing the particulate porous cross-linked resin.

2. The toner according to claim 1, wherein the colored particulate material further comprises a layered inorganic compound in which an interlayer ion is partially exchanged with an organic ion.

3. The toner according to claim 2, wherein an interlayer cation of the layered inorganic compound is partially exchanged with an organic cation.

4. The toner according to claim 2, wherein the colored particulate material is prepared by a method comprising:
dispersing or emulsifying a toner constituent mixture comprising the layered inorganic compound in an aqueous medium.

5. A method for manufacturing a toner, comprising:
mixing a particulate porous cross-linked resin having pores on a surface thereof and a volume average particle diameter of from 25 to 50 μm with a pre-toner comprising:
a colored particulate material comprising a binder resin, a colorant, and a release agent; and
an external additive; and
removing the particulate porous cross-linked resin.

6. The method for manufacturing a toner according to claim 5, wherein the particulate porous cross-linked resin is removed with a sieve having openings smaller than the volume average particle diameter thereof.

7. The method for manufacturing a toner according to claim 5, further comprising:
mixing the colored particulate material and the external additive to prepare the pre-toner.

8. The method for manufacturing a toner according to claim 5, wherein the particulate porous cross-linked resin has a cross-linking density of from 3 to 15% by weight, a total volume of the pores of from 0.01 to 0.50 cc/g, a specific surface area of from 5 to 50 m²/g, and an average diameter of the pores of from 0.01 to 2.0 μm.

9. The method for manufacturing a toner according to claim 5, wherein the particulate porous cross-linked resin is prepared by copolymerizing 50 to 96 parts by weight of an alkyl acrylate or alkyl methacrylate, 3 to 15 parts by weight of a polyfunctional monomer having 2 or more vinyl groups, and 1 to 35 parts by weight of a copolymerizable monomer, in the presence of a pore-forming agent.

10. The method for manufacturing a toner according to claim 5, wherein the external additive comprises an external additive having a specific surface area of from 20 to 300 m²/g measured by BET method.

11. The method for manufacturing a toner according to claim 5, wherein the external additive comprises at least 2 external additives.

12. The method for manufacturing a toner according to claim 5, wherein the external additive comprises at least one member selected from the group consisting of a silica, a titanium compound, an alumina, a cerium oxide, a calcium carbonate, a magnesium carbonate, a calcium phosphate, a fluorine-containing particulate resin, a silica-containing particulate resin, and a nitrogen-containing particulate resin.

13. The method for manufacturing a toner according to claim 12, wherein the titanium compound is prepared by partially reacting TiO(OH)₂, which is prepared by a wet method, with a silane compound or a silicone oil.

14. The method for manufacturing a toner according to claim 12, wherein the titanium compound has a specific gravity of from 2.8 to 3.6.

15. The method for manufacturing a toner according to claim 5, wherein the colored particulate material is prepared by a method comprising:
dissolving or dispersing toner constituents comprising the binder resin comprising a modified polyester resin capable of reacting with a compound having an active hydrogen group, in an organic solvent or dispersion medium, to prepare a toner constituent mixture liquid;
dispersing the toner constituent mixture liquid in an aqueous medium containing a particulate resin while reacting the modified polyester resin with the compound having an active hydrogen group, to prepare a dispersion containing the colored particulate material; and
removing the organic solvent or dispersion medium from the dispersion.

16. A developer, comprising a carrier and the toner according to claim 1.

17. An image forming method, comprising:
charging an image bearing member;
irradiating the image bearing member with light to form an electrostatic latent image on the image bearing member;
developing the electrostatic latent image with a toner to form a toner image on the image bearing member; and
transferring the toner image onto a transfer material optionally via an intermediate transfer medium,
wherein the toner is the toner according to claim 1.

18. The image forming apparatus, comprising:
an image bearing member configured to bear an electrostatic latent image;
a charger configured to charge the image bearing member;
an image irradiator configured to irradiate the image bearing member with a light beam to form the electrostatic latent image on the image bearing member;
an image developer configured to develop the electrostatic latent image with a toner to form a toner image on the image bearing member; and
an image transferer configured to transfer the toner image onto a transfer material optionally via an intermediate transfer medium,
wherein the toner is the toner according to claim 1.

19. A process cartridge detachably attachable to an image forming apparatus, comprising:
an image bearing member configured to bear an electrostatic latent image; and
an image developer configured to develop the electrostatic latent image with a toner,
wherein the toner is the toner according to claim 1.
